(19) United States
(12) Patent Application Publication
(10) Pub. No.: US 2010/0272936 A1
(43) Pub. Date: Oct. 28, 2010

(54) MULTILAYER STRUCTURE FOR THE MANUFACTURE OF PACKAGING AND PACKAGING THEREOF

(75) Inventors: Michael D. White, Midland, MI (US); Carlos E. Ruiz, Katy, TX (US); Claudia Hernandez, Lake Jackson, TX (US); Steven R. Jenkins, Clare, MI (US)

Correspondence Address: The Dow Chemical Company, P.O. BOX 1967, Midland, MI, 48641, US

(73) Assignee: DOW GLOBAL TECHNOLOGIES INC., Midland, MI (US)

(21) Appl. No.: 12/742,537

(22) PCT Filed: Nov. 21, 2008
(86) PCT No.: PCT/US2008/084264

§ 371 Date: May 12, 2010

Related U.S. Application Data
(60) Provisional application No. 60/990,379, filed on Nov. 27, 2007.

(51) Int. Cl. B32B 1/08; B32B 27/30; B32B 27/08; B32B 7/02; C09J 7/00; B29C 47/06

(52) U.S. Cl. 428/35.4; 428/522; 428/518; 428/520; 428/515; 428/212; 428/354; 428/76; 264/173.13; 428/36.6

(57) ABSTRACT

A multilayer structure comprises at least one barrier layer comprising at least one vinylidene chloride polymer, at least one UV protecting layer, and at least one reflective layer wherein none of these layers also serve as a sealing layer. The multilayer structure is preferably a film, more preferably in the form of a pouch, preferably for packaging flowable product, especially milk. When used as a milk pouch, the structure is more effective at protecting milk from deterioration at ambient temperature and humidity than is a similar multilayer structure having an ethylene vinyl alcohol barrier layer. The multilayer structure preferably has more than one reflective layers and is preferably in the form of a pillow pouch. The invention also includes a process comprising steps of (a) supplying at least one first composition comprising at least one vinylidene chloride polymer, at least one second composition comprising UV absorbing pigment or agent, and at least one third composition comprising at least one light reflective material, to a coextrusion die and (b) coextruding the first, second and third compositions as layers referred to herein after as the barrier layer, UV protecting layer, and reflective layer respectively.

### CROSS-REFERENCE STATEMENT

This application claims benefit of U.S. Provisional Application Ser. No. 60/990,379, filed on Nov. 27, 2007.

### BACKGROUND

This invention involves a multilayer structure including at least one barrier layer comprising polyvinylidene chloride and at least one ultraviolet (UV) protecting layer as well as packaging comprising the multilayer structure. The multilayer structure is preferably a multilayer film. The packaging is preferably in the form of a pouch. At least one UV protecting layer is preferably pigmented.

Flowable materials have long been packaged. In the case of items known to have relatively short shelf lives, especially foods and beverages, the packaging is often a rigid box such as a juice box with a foil lining or foil laminate to serve as a barrier to oxygen, light and aroma. Foil has very limited extensibility and is, therefore, known to crack and tear. Deposited layers of other metals onto polymeric substrates also have the disadvantage of being susceptible to cracks and pinholes. Other barriers such as silicon oxides have been proposed in U.S. Pat. No. 5,508,075 where the silicon oxide is plasma deposited. Silicon oxide or glass is a barrier to oxygen and aroma but has not solved the problems of retaining shelf life sufficiently well to find widespread use.

Boxes with foil laminate linings are standard for aseptically packaging UHT (Ultra-High Temperature) milk because they provide adequate protection for a relatively long shelf life. However, such boxes require exacting manufacturing processes because the foil is sensitive to stresses and may crack and tear. Furthermore, there are relatively small tolerances for seams, size, closures, spouts, straw entry points, integral straws and the like.

Pouches have been proposed because they involve broader manufacturing tolerances since seams can have some variance in width and other package features can be integral. Pouches are also lower cost packaging solutions and offer a lower package to product ratio: Provide better sustainability in that they maximize performance and minimize the combined use of scarce resources. In pouches, either ethylene vinyl alcohol (EVOH) or polyvinylidene chloride (PVDC) has been proposed as barrier layers. See, for instance, U.S. Pat. No. 6,177,465 and US Pregrant Publication 20070246391. Such pouches have not proven to give adequate shelf life for sensitive foods such as UHT milk for which the standard packaging remains a polymer/foil/paper laminate to achieve at least 90 days of shelf life at a relative humidity of at least about 50 percent and a temperature of at least about 25° C. Such a laminate normally weighs about 4 percent of the weight of the packaged milk when the milk is packaged in 1 liter (I) portions.

While multilayer structure, especially multilayer film pouch, packaging of flowable materials is applicable to many more products than milk, milk is used herein as the example package content because it requires more protection than many products to remain consumable after storage. Furthermore, the distinction between consumable and not consumable is distinct. Therefore, even when milk is used as the exemplary content, it should not be interpreted as limiting the invention

It has been recognized in such references as “Over de Smaak Van Gepasteuriseerde Milk Verpakt in Zakjas Van Polyetheen”, Nizo Nieuws 1966 by H. T. Badings and L. Radema and U.S. Pat. No. 4,521,437 that layers incorporating carbon black can help protect milk. However, the carbon black has been used in structures different from those of the present invention.

It would be desirable to have a material capable of protecting UHT milk for a period of at least about 90 days, preferably at least about 120 days, more preferably at least about 150 days, most preferably at least about 6 months which would also have one or more of the following characteristics with increasing preference for increasing numbers of the characteristics: (1) a weight less than that of the polymer/foil/paper rigid container standardly used for UHT milk, preferably less than about 4, more preferably less than about 3, most preferably less than about 2.5 weight percent of the packaged milk in 1000 ml portions; (2) less susceptibility to cracking in the barrier layer than foil; (3) capability to protect milk stored at ambient conditions for a period longer than that achieved with a comparable laminate using a different barrier layer such as ethylene vinyl alcohol (EVOH) under the same conditions; (4) less exacting packaging manufacture than a standard polymer/foil/paper laminate milk box or a standard polymer/foil or metallized film/polymer laminate for milk pouch; (5) producible by coextrusion; or (6) ability to facilitate transportation or storage (or both) at ambient rather than refrigerated temperatures or at least raise the temperature at which a packaged product can be stored, transported, or both over the temperature that would be required to achieve the same shelf life or percentage of consumable product using alternate packaging such as a different barrier layer such as ethylene vinyl alcohol (EVOH).

### SUMMARY OF THE INVENTION

It has now been found that packaging having at least one polyvinylidene chloride barrier layer and at least one dark pigmented layer or other UV protecting layer, or at least one dark pigmented polyvinylidene chloride layer provides desirable protection for the shelf life of packaged products such as milk. The packaging preferably also has at least one reflective (or radiant barrier) layer to minimize the transfer of thermal energy from ambient conditions to the product such as milk or to reflect light. More preferably there are at least 2 such reflective layers. The external layer is preferably suitable for printing.

The invention includes a multilayer structure comprising at least one barrier layer comprising at least one vinylidene chloride polymer and at least one UV protecting layer, and at least one reflective layer wherein none of these layers is also a sealant layer. The UV protecting layer is preferably pigmented with a dark pigment. The reflective layer preferably comprises white or silver pigment or a combination thereof or has a metallic coating. In a preferred embodiment, there is more than one reflective layer.

The invention additionally includes packaging comprising the multilayer structure which comprises at least one barrier layer comprising at least one vinylidene chloride polymer and at least one UV protecting layer, and at least one reflective layer. The packaging is preferably of flowable materials and, independently, is preferably in the form of a pouch, preferably a pillow pouch. The milk pouch is preferably capable of maintaining potability (acceptable organoleptic qualities) of milk at ambient (unrefrigerated) temperatures and humidity for a period longer than that of a similar pouch wherein the barrier layer is ethylene vinyl alcohol compared at a relative thickness expected to have comparable oxygen barrier measured according to the procedures of ASTM E3985.

Moreover, the invention includes a process of (a) supplying at least one first composition comprising at least one vinylidene chloride polymer, at least one second composition comprising UV absorbing pigment or agent, and at least one third composition comprising at least one reflective pigment to a coextrusion die and (b) coextruding the first and second composition as layers. The process preferably also includes a step of expanding the coextruded layers to form a multilayer structure, preferably a film. Preferably at least one additional composition is also supplied to form at least one reflective layer, at least one sealing layer or, more preferably both.

### DRAWINGS

There are no drawings.

### DETAILED DESCRIPTION OF THE INVENTION

### Definitions

“Flowable product” is used herein to mean products including low viscosity fluids, e.g. milk, water, juice, wine and non-carbonated beverages, where the viscosity can range from about 0.001 to 0.5 Pascal-seconds; high viscosity fluids, e.g. condiments, oils, syrups, sauces, etc. where the viscosity can range from 0.51 to 25 Pascal-seconds (as determined by the procedures of ASTM D-2393): and fluid/solid mixtures, e.g. diced fruit in syrup or juice, soups, apple sauce, puddings, flavored gelatins, and even small or comminuted solids such as nuts or shelled nuts, sunflower seeds, trail mix, and the like, and other consumable foods such as beans and franks, soup with noodles, and the like. Similarly sized or textured non-food products are also flowable products.

As used herein the term “multilayer structure” refers to any structure having more than one layers which are at least partially contiguous and preferably, but optionally, coextensive.

As used herein the term “film” refers to a sheet, laminate, web or the like or combinations thereof, having length and breadth dimensions and having two major surfaces with a thickness there between. A film can be a monolayer film (having only one layer) or a multilayer film (having two or more layers). A film, in most instances, has a thickness of up to about 20 mils (5×10⁻⁴ m).

The term “multilayer film” means a film having two or more layers. A multilayer film is composed of more than one layer preferably composed of at least two different compositions, advantageously extending substantially the length and breadth dimensions of the film. Layers of a multilayer film are usually bonded together by one or more of the following methods: coextrusion, extrusion coating, vapor deposition coating, solvent coating, emulsion coating, or suspension coating. A film, in most instances, has a thickness of up to about 30-35 mils (7.5−8×10⁻⁴ m).

The term “tie layer” or “adhesive layer” or “bonding layer” means an inner layer having a primary purpose of providing interlayer adhesion to directly adjacent or contiguous layers, for instance between the interlayer and a glass. The tie layer may also impart other characteristics to the multicomponent structure of which it is a part.

The term “barrier layer” as used herein designates a layer of a multilayer film having a lower permeance or transmission of one or more permeants, typically gases (for instance, oxygen, water vapor or liquid, chemical compounds, flavorants or odorants, preferably oxygen and water) than other layers of the multilayer film. A “barrier resin” or “barrier polymer” means a polymer or polymer composition suitable for use in forming a barrier layer. The barrier resin would not provide lower permeance or transmission to chemicals capable of solublizing it, although there would typically be very few of such chemical compounds.

“Skin layer” means an outer layer including an outside layer, thus any layer which is on an exterior surface of a film or other multicomponent structure. A surface layer advantageously provides wear resistance, protection of inner layers which may be more susceptible to deterioration, a desired degree of adhesion or resistance to adhesion to a material or object it is adapted to contact, or similar characteristics, generally different from those of inner layers.

As used herein “contiguous” or “directly adjacent,” when referred to two layers, is intended to refer to two layers that are directly touching or adhered one to the other. In contrast, as used herein, the word “between”, as applied to a film layer expressed as being between two other specified layers, includes both direct adherence of the subject layer to the two other layers it is between, as well as lack of direct adherence to either or both of the two other layers the subject layer is between, that is, one or more additional layers can be imposed between the subject layer and one or more of the layers the subject layer is between.

“Laminate” (noun) refers to a material made up of two or more layers of material bonded or adhered together, and includes a multilayer film, such as a coextruded film. A rigid laminate is a laminate having sufficient thickness or at least one sufficiently rigid layer to prevent draping and sustain its shape upon handling.

“Laminate” (verb) as used herein, refers to adhering or joining two or more surfaces together, for instance joining separately produced films together to form a multilayer film. There are many methods of laminating within the skill in the art, for instance by use of heat, wave radiation, adhesives, pressure, and the like.

“Extrusion,” and “extrude,” refer to the process of forming continuous shapes by forcing a molten plastic material through a die, followed by cooling or chemical hardening. Immediately prior to extrusion through the die, the relatively high-viscosity polymeric material is fed into a rotating screw, which forces it through the die.

“Coextrusion,” and “coextrude,” refer to the process of extruding two or more materials through a single die with two or more orifices arranged so that the extrudates merge and weld together into a laminar structure before cooling or chilling, that is, quenching. Coextrusion is often employed as an aspect of other processes, for instance, in film blowing, casting film, and extrusion coating processes.

“Blown film” or “film blowing” refers to a process for making a film in which a polymer or copolymer is extruded to form a bubble filled with heated air or another hot gas in order to stretch the polymer. Then, the bubble is collapsed and collected in flat film form.

“Pouch” as used herein includes a bag, or similar container or packaging having substantially flexible sides or continuous portion. A pouch optionally has one or more rigid or semi-rigid portions, for instance a rigid bottom to facilitate standing on a shelf, a stiffer or rigid portion for insertion of straw, tap, valve or other removal means, one or more bands for stability, a label; one or more back, front or sides or portions thereof to facilitate standing, a stiffer portion for closure or reclosure, an attached removal means or a combination thereof. A pouch is optionally either pre-made or made at the point of packaging. Although use of the term, pouch, is not limited to the common forms, common forms include a pouch formed from a centerfolded film sealed on two or more edges and a pouch formed from two contiguous layers of film sealed on three or more edges. In many instances, two edges of the centerfolded film or 3 edges of the contiguous layers are sealed before filling, then, after the pouch is filled, the remaining edges are sealed together. Sometimes a tube is formed either by direct coextrusion or by sealing outer edges of a strip of film, then the tube is separated into portions by sealing and cutting into pouches. The term, pouch, is not limited to any of these methods of manufacture or to the common form frequently referred to as a “pillow pouch” because of its pillow-like shape. A pouch is optionally used inside another structure, for instance a box or bottle, for instance, as a liner. A pouch is optionally adhered or laminated to another such structure.

“Seal” (noun) means a bond of a first region of a film surface or component surface to a second region of a film surface or component surface (or opposing surfaces). In heat sealing, it is created by heating (for example, by means of a heated bar, hot wire, hot air, infrared radiation, and ultrasonic sealing) the regions (or surfaces) to at least their respective softening points.

“Heat-seal” (also known as a “heat-weld”) refers to the union of two films by bringing the films into contact, or at least close proximity, with one another and then applying sufficient heat and pressure to a predetermined area (or areas) of the films to cause the contacting surfaces of the films in the predetermined area to become molten and intermix with one another, thereby forming an essentially inseparable bond between the two films in the predetermined area when the heat and pressure are removed therefrom and the area is allowed to cool.

The term “seal” and “sealing” (verbs) are used herein to designate any method of joining two or more surfaces, especially a first region of a surface to a second region of a surface (or opposing surfaces). Sealing is used for seaming, bonding, sealing, joining, adhering and the like when two or more surfaces are joined. Sealing optionally takes the form of heat or thermal sealing. Sealing optionally takes the form of pressure sealing wherein pressure is supplied to achieve a seal. Other options include the use of adhesives and the like.

“Seal layer” (or “sealing layer” or “heat seal layer” or “sealant layer”) means the outer layer(s) involved in the sealing of the film to itself, another layer of the same or another film, another article which is not a film or a combination thereof.

“Filled” with respect to the package herein refers to a package that has been filled with a flowable product in a manner consistent with a commercial filling operation. Thus, a filled package may or may not be filled to 100 percent of its capacity, and is optionally filled to e.g., 50, 60, 70, 80, or 90 percent of its capacity, or higher or lower.

“Centerfolded film” herein refers to a film that has been folded on itself along its longitudinal central axis; and alternatively includes two separate films that are brought together in a congruent arrangement such that a pouch can be made therefrom.

The term “polyethylene” means a homopolymer of ethylene or an ethylene/alpha-olefin copolymer having a majority of its mer units derived from ethylene.

The term “ethylene/alpha-olefin copolymer” designates copolymers of ethylene with one or more comonomers selected from C₃ to C₂₀ alpha-olefins, such as 1-butene, 1-pentene, 1-hexene, 1-octene, methyl pentene and the like. Included are polymer molecules comprising long chains with relatively few side chain branches obtained by low pressure polymerization processes and the side branching that is present is short compared to non-linear polyethylenes (for instance, LDPE, a low density polyethylene homopolymer). Ethylene/alpha-olefin copolymers generally have a density in the range of from about 0.86 g/cm³ to about 0.94 g/cm³. The term linear low density polyethylene (LLDPE) is generally understood to include that group of ethylene/alpha-olefin copolymers which fall into the density range of about 0.915 to about 0.94 g/cm³ or 0.930 when linear polyethylene in the density range from about 0.926 to about 0.95 g/cm³ is referred to as linear medium density polyethylene (LMDPE). Lower density ethylene/alpha-olefin copolymers may be referred to as very low density polyethylene (VLDPE), often used to refer to the ethylene/butene copolymers commercially available from Union Carbide Corporation and ultra-low density polyethylene (ULDPE), typically used to refer to certain ethylene/octene copolymers supplied by the Dow Chemical Company, with a density ranging from about 0.88 to about 0.915 g/cm³. LLDPE is an abbreviation for linear low density polyethylene and refers to copolymers of ethylene having: (1) at least one higher-alpha-olefin such as butene, octene, hexene and the like as a comonomer; (2) a density of from about 0.915 to as high as about 0.930 grams per cubic centimeter; (3) molecules comprising long chains with few or no branches or cross-linked structures; and, (4) being produced at low to medium pressures by copolymerization using heterogeneous catalysts based on transition metal compounds of variable valance.

The phrase ethylene/alpha-olefin copolymer also includes homogeneous polymers such as metallocene-catalyzed EXACT™ linear homogeneous ethylene/alpha-olefin copolymer resins commercially available from the Exxon Chemical Company, of Baytown, Tex.; TAFMER™ linear homogeneous ethylene/alpha-olefin copolymer resins commercially available from the Mitsui Petrochemical Corporation; and long-chain branched, metallocene-catalyzed homogeneous ethylene/alpha-olefin copolymers commercially available from The Dow Chemical Company, for instance, known as AFFINITY™ or ENGAGE™ resins. The phrase “homogeneous polymer” refers to polymerization reaction products of relatively narrow molecular weight distribution and relatively narrow composition distribution. Homogeneous polymers are structurally different from heterogeneous polymers (for instance, ULDPE, VLDPE, LLDPE, and LMDPE) in that homogeneous polymers exhibit a relatively even sequencing of comonomers within a chain, a mirroring of sequence distribution in all chains, and a similarity of length of all chains, that is, a narrower molecular weight distribution. Furthermore, homogeneous polymers are most often prepared using metallocene, or other single-site type catalysts, rather than using Ziegler-Natta catalysts. Such single-site catalysts typically have only one type of catalytic site, which is believed to be the basis for the homogeneity of the polymers resulting from the polymerization.

The term “substantially linear” means that, in addition to the short chain branches attributable to homogeneous comonomer incorporation, the ethylene polymer is further characterized as having long chain branches in that the polymer backbone is substituted with an average of 0.01 to 3 long chain branches/1000 carbons. Preferred substantially linear polymers are substituted with from 0.01 long chain branch/1000 carbons to 1 long chain branch/1000 carbons, and more preferably from 0.05 long chain branch/1000 carbons to 1 long chain branch/1000 carbons.

The substantially linear ethylene/α-olefin polymers are made by a continuous process using suitable constrained geometry catalysts, preferably constrained geometry catalysts as disclosed in U.S. Pat. Nos. 5,132,380, 5,703,187; and 6,013,819. The monocyclopentadienyl transition metal olefin polymerization catalysts taught in U.S. Pat. No. 5,026,798 and are also suitable for use in preparing the polymers of the present invention.

Long chain branching is defined herein as a branch having a chain length greater than that of any short chain branches which are a result of comonomer incorporation. The long chain branch can be as long as about the same length as the length of the polymer back-bone. Long chain branching can be determined using methods within the skill in the art, for instance by using 13C nuclear magnetic resonance (NMR) spectroscopy measurements, with quantification using, for instance, the method of Randall (Rev. Macromol. Chem. Phys., C29 (2&3), p. 275-287).

In substantially linear ethylene/α-olefin polymers, the I₁₀/I₂ ratio indicates the degree of long chain branching, that is, the higher the I₁₀/I₂ ratio, the more long chain branching in the polymer. Generally, the I₁₀/I₂ ratio of the substantially linear ethylene/α-olefin polymers is at least about 5.63, preferably at least about 7, especially at least about 8 or above, and as high as about 25. The melt index of a substantially linear ethylene polymer is measured according to ASTM D-1238 condition 190° C./2.16 Kg (formerly known as Condition E).

The term “single site catalysts” is recognized in the art as referring to catalysts which have less diversity in the individual polymer chains produced than is observed in polymers made using Ziegler Natta catalysts. This diversity is evidenced in broader MWD. Single site catalysts include single site metallocene or single site constrained geometry catalyst; these are exemplified by U.S. Pat. No. 4,937,299 (Ewen et al.), U.S. Pat. No. 5,218,071 (Tsutsui et al.), U.S. Pat. Nos. 5,278,272, 5,324,800, 5,084,534, 5,405,922, 4,588,794, 5,204,419.

HDPE is an abbreviation for high density polyethylene and designates polyethylene having a density from about 0.950 to 0.965 g/cm³. HDPE is frequently an ethylene homopolymer.

As used herein, the term “ethylene/vinyl acetate copolymer” or “EVA” designates a copolymer formed from ethylene and vinyl acetate monomers wherein the ethylene derived units are present in amounts of at least 50 percent by weight and the vinyl acetate derived units are present in amounts of less than 50 percent by weight. The vinyl acetate content may range from a low of 2 or 3 percent to a high of 40 or 50 percent depending upon the desired properties and is generally from 1 to 30 percent by weight, with 12 to 35 weight percent vinyl acetate often used for tie layer applications. In polymer blends, EVA is often added to improve bonding between polymer phases.

As used herein, the term “ethylene/vinyl alcohol copolymer” or “EVOH” designates a copolymer formed from ethylene and vinyl alcohol, prepared by for example, hydrolysis or saponification of vinyl acetate copolymers, or by chemical reactions with polyvinyl alcohol. The degree of hydrolysis is preferably at least 50 percent and more preferably at least 85 percent. The ethylene comonomer is generally present in a range of about 15 to about 65 weight percent.

All percentages, preferred amounts or measurements, ranges and endpoints thereof herein are inclusive, that is, “less than about 10” includes about 10. “At least” is, thus, equivalent to “greater than or equal to,” and “at most” is, thus, equivalent “to less than or equal to.” Numbers herein have no more precision than stated. Thus, “115” includes at least from 114.5 to 115.49. Furthermore, all lists are inclusive of combinations of two or more members of the list. All ranges from a parameter described as “at least,” “greater than,” “greater than or equal to” or similarly, to a parameter described as “at most,” “up to,” “less than,” “less than or equal to” or similarly are preferred ranges regardless of the relative degree of preference indicated for each parameter. Thus a range that has an advantageous lower limit combined with a most preferred upper limit is preferred for the practice of this invention. All amounts, ratios, proportions and other measurements are by weight unless stated otherwise. All percentages refer to weight percent based on total composition according to the practice of the invention unless stated otherwise. Except in the examples, or where otherwise indicated, all numbers expressing quantities, percentages, OH numbers, functionalities and so forth in the specification are to be understood as being modified in all instances by the term “about.” Unless stated otherwise or recognized by those skilled in the art as otherwise impossible, steps of processes described herein are optionally carried out in sequences different from the sequence in which the steps are discussed herein. Furthermore, steps optionally occur separately, simultaneously or with overlap in timing. For instance, such steps as heating and admixing are often separate, simultaneous, or partially overlapping in time in the art. Unless stated otherwise, when an element, material, or step capable of causing undesirable effects is present in amounts or in a form such that it does not cause the effect to an unacceptable degree it is considered substantially absent for the practice of this invention. Furthermore, the terms “unacceptable” and “unacceptably” are used to refer to deviation from that which can be commercially useful, otherwise useful in a given situation, or outside predetermined limits, which limits vary with specific situations and applications and can be set by predetermination, such as performance specifications. Those skilled in the art recognize that acceptable limits vary with equipment, conditions, applications, and other variables but can be determined without undue experimentation in each situation where they are applicable. In some instances, variation or deviation in one parameter can be acceptable to achieve another desirable end.

The term “comprising”, is synonymous with “including,” “containing,” or “characterized by,” is inclusive or open-ended and does not exclude additional, unrecited elements, material, or steps. The term “consisting essentially of” indicates that in addition to specified elements, materials, or steps; unrecited elements, materials or steps are optionally present in amounts that do not unacceptably materially affect at least one basic and novel characteristic of the subject matter. The term “consisting of” indicates that only stated elements, materials or steps are present except that unrecited elements, materials or steps may be present to an extent that has no appreciable effect, or are substantially absent.

The invention includes a multilayer structure including at least one barrier layer and at least one UV protecting layer.

The barrier layer is a barrier to permeation of oxygen and preferably comprises at least one vinylidene chloride polymer. Vinylidene chloride polymers (also known as vinylidene chloride resins, interpolymers of vinylidene chloride, vinylidene chloride interpolymers, copolymers of vinylidene chloride, and PVDC) are well-known in the art. See, for example, U.S. Pat. Nos. 3,642,743 and 3,879,359. As used herein, the term “interpolymer of vinylidene chloride,” vinylidene chloride interpolymer” or “PVDC” encompasses copolymers, terpolymers, and higher polymers wherein the major component is vinylidene chloride, optionally and preferably having one or more mono-ethylenically unsaturated monomer (monounsaturated comonomer) copolymerizable with the vinylidene chloride monomer such as vinyl chloride, alkyl acrylates, alkyl methacrylates, acrylic acid, methacrylic acid, itaconic acid, acrylonitrile, and methacrylonitrile. In one embodiment this invention is particularly applicable to alkyl acrylate vinylidene chloride polymers (acrylate PVDC). The vinylidene chloride polymer has monomer units from vinylidene chloride and at least one alkyl acrylate. Such alkyl acrylates include alkyl acrylates having alkyl groups of from 1 to 5 carbon atoms and combinations thereof, preferably methyl acrylate, ethyl acrylate, or butyl acrylate, or combinations thereof, more preferably methyl or butyl acrylate, or combinations thereof, more preferably methyl acrylate or combinations therewith. In another embodiment, the vinylidene chloride polymer optionally also has at least one additional monounsaturated comonomer polymerizable with vinylidene chloride and an alkyl acrylate, such as vinyl chloride, alkyl methacrylates, acrylic acid, methacrylic acid, itaconic acid, acrylonitrile, methacrylonitrile, and combinations thereof, preferably alkyl methacrylates, acrylic acid, methacrylic acid, itaconic acid, acrylonitrile, methacrylonitrile, or combinations thereof.

The barrier layer or layers advantageously comprise at least about 80, preferably at least about 85, more preferably at least about 90, most preferably at least about 95 percent by weight of polyvinylidene chloride polymer or combination thereof. The remainder of each layer is optionally at least one polymer compatible with vinylidene chloride polymer, additives within the skill in the art such as stabilizers, processing agents, antiblock agents, slip agents, and combinations thereof.

The barrier layer is preferably at least about 8, more preferably at least about 10, most preferably at least about 12, and independently preferably at most about 20, more preferably at most about 18, most preferably at most about 16 percent by volume of the multilayer structure of the invention. In a preferred structure where the layers are coextensive, relative volume substantially corresponds to relative thickness. In the more preferred multilayer film of the invention, the total film thickness is preferably at least about 2.2 mils (55.9 μm), more preferably at least about 2.7 mils (68.6 μm), most preferably at least about 3.3 mils (83.8 μm), and independently preferably at most about 5.5 mils (139.7 μm), more preferably at most about 5.0 mils (127 μm), most preferably at most about 4.5 mils (114.3 μm).

In the practice of the invention, barrier layers suitable for different applications are achievable by such means as increasing the volume or thickness of the PVDC layer to increase barrier properties or using different PVDC copolymers that have different barrier values. For example, one can use a thinner layer of a higher barrier PVDC material or a thicker layer of a lower barrier PVDC material.

The UV protecting layer, also called the UV absorbing layer or UV barrier layer preferably includes at least one layer comprising at least one dark pigment, that is a pigment capable of absorbing ultra violet (UV) light, that is, light having a wave length between about 200 and 400 nm or other UV absorbent. Pigments capable of absorbing UV light are within the skill in the art and include, for instance, carbon black, HALS (hindered amine light scattering additives) and combinations thereof. A layer comprising such a dark pigment is referred to herein as a dark layer. In a less preferred embodiment, other UV absorbents such as HALS or combinations thereof are used to absorb UV light. Pigment has the advantage of continuing to absorb UV light after initial exposure whereas chemical absorbents sometimes undergo chemical changes as a result of absorption. Such absorbents may also affect the surrounding polymer or be limited in the amounts to which foodstuffs may be exposed. The amount of pigment or absorbent used is preferably sufficient to absorb sufficient UV light to protect the intended content of packaging made from the multilayer structure from deterioration caused by UV light. Those skilled in the art will recognize that this amount will vary with such factors as the package content, the pigment or absorbent, the amount of UV light exposure and the like but can be determined without undue experimentation. In general an amount of dark pigment sufficient to result in a L* (transmittance) value as determined by the procedures of ASTM E308-06 of the combination of layers with UV absorbing material of preferably at most about 2, more preferably at most about 1.5, most preferably at most about 1.0 is sufficient to absorb UV light to which a package will be exposed. This L* is suitably provided, for instance by a loading of preferably at most about 5, more preferably at most about 4, most preferably at most about 3 percent by weight carbon black in one or more layers that together make up about 20 percent of the volume of a multilayer film.

In addition to the UV absorbing pigment or additive, each UV protecting layer comprises at least one polymer. The polymer is suitably any polymer within the skill in the art for making multilayer structures or films. Those skilled in the art recognize that the polymer is selected for its properties that are desirable in a particular end use. For packaging, particularly packaging flowable products, especially liquids such as milk, preferred polymers include low density polyethylene, ethylene-octene copolymers, ethylene-vinyl acetate copolymers, ethylene methyl acrylate copolymers or combinations thereof, with ethylene polymers or combinations thereof preferred. As in the case of the barrier layer, each UV protecting layer optionally contains additives within the skill in the art such as stabilizers, processing agents, antiblock agents, slip agents, and combinations thereof.

In one embodiment, there are optionally more than one UV protecting layers, preferably dark layers, because in a multilayer film with greater than 5 layers, it is generally not feasible to have a single thick layer to accomplish this task. Doing so would require the operator to reduce extrusion rates of several extruders to allow one extruder to increase the overall thickness of one layer of the film. Instead, it is better to add pigment to several layers, and run all of the extruders at a high rate. This allows an operator to build sufficient thickness of pigmented layers without having to take a rate penalty. The number of layers is preferably that number adequate to provide the preferred UV absorbance with a convenient loading of the selected UV absorbent or combination thereof. In most instances, however, adequate UV absorbance is attainable with one layer containing a pigment such as carbon black. The combined thickness of such UV protecting layers is preferably at least about 0.3 mil (7.6 μm), more preferably at least about 0.5 mils (12.7 μm), most preferably at least about 0.7 mil (17.8 μm), and independently preferably at most about 1.5 mils (38.1 μm), more preferably at most about 1.3 mils (33.0 μm), most preferably at most about 1.1 mil (27.9 μm). In a preferred multilayer film such layer or layers comprise preferably at least about 10, more preferably at least about 15, most preferably at least about 20, and independently preferably at most about 40, more preferably at most about 35, most preferably at most about 30 volume percent of the structure.

Protection from oxygen provided by at least one barrier layer combined with UV protection and some temperature protection provided by at least one UV protecting layer preferably enable a product such as milk to be transported at ambient temperatures rather than requiring refrigeration. Additional protection is preferably added by use of at least one reflective layer.

A reflective layer is a layer that reflects visible and, preferably, also UV light. It is perceived as white or light colored, for instance silver or other metallic colored. Such layers provide protection from light, and preferably also some protection from thermal radiation, that is, heat. Furthermore, customers tend to prefer a white outer layer especially for products such as milk. Light colors also provide a preferred surface for printing. Reflective layers are within the skill in the art and often contain silver, aluminum, or other metallic pigment or coating or have a white pigment such as titanium dioxide or combinations thereof. Reflective layers are within the skill in the art. In the practice of the invention, the reflective layer is preferably sufficiently reflective to accomplish those of the following purposes appropriate for a preselected end use: protection from light, protection from heat, aesthetic appeal, printability, or a combination thereof. In most instances, an amount of reflective or white pigment sufficient to result in a L* (reflectance) value as determined by the procedures of ASTM E308-06 of preferably at least about 75, more preferably at least about 80, most preferably at least about 85 is sufficient to provide the desired qualities. This L* is suitably provided, for instance by a loading of preferably at least about 2, more preferably at least about 4, most preferably at least about 6, and independently preferably at most about 20, more preferably at most about 15, most preferably at most about 10 percent by weight of titanium dioxide based on weight of polymer in the light layer or layers. For the same reasons explained for the UV protecting layer, multiple reflective layers are often preferable. The thickness of the reflective layer or layers combined is preferably at least about 1 mil (25.4 μm), more preferably at least about 1.25 mils (31.8 μm), most preferably at least about 1.50 mils (38.1 μm), and independently preferably at most about 2.50 mils (63.5 μm), more preferably at most about 2.25 mils (57.2 μm), most preferably at most about 2.0 mils (50.8 μm). In a preferred multilayer film, such layers comprise preferably at least about 10, more preferably at least about 20, most preferably at least about 30, and independently preferably at most about 60, more preferably at most about 50, most preferably at most about 40 volume percent of the structure. When the reflective layer also reflects at least about 95 percent of UV light to which the film or package is exposed, a UV absorbing layer is unnecessary, or stated otherwise, the reflecting layer is also the UV protecting layer. Other reflecting layers that reflect UV light, but to a reduced extent reduce the need for the amount of UV absorbing additive or thickness of UV protecting layer or layers. Those skilled in the art can measure the penetration or reflection of UV light to determine the amount to be absorbed by the UV protecting layers.

In addition to the reflective pigment or coating, other additives to enhance printability or combination thereof, each reflective layer comprises at least one polymer. The polymer is suitably any polymer within the skill in the art for making multilayer structures or films. Those skilled in the art recognize that the polymer is selected for its properties that are desirable in a particular end use. For packaging, particularly packaging flowable products, especially liquids such as milk, preferred polymers, especially for the outer layer, include linear low density polyethylene (LLDPE), ethylene-octene copolymers, substantially linear ethylene polymers, low density polyethylene, tough polymers such as nylon or polypropylene or combinations thereof, with the ethylene polymers or combinations thereof preferred, and LLDPE or combinations thereof, especially with other ethylene polymers most preferred. In a preferred embodiment when more than one layer of a multilayer film of the invention is reflective, it is preferred that these layers serve other purposes as well. That is, rather than adding layers only for the purpose of introducing or increasing reflection of light or heat, it is preferred to use white or light pigment in layers otherwise present such as tie layers. For that reason the additional reflective layers preferably comprise polymers useful for purposes such as ethylene vinyl acetate (EVA) or substantially linear ethylene polymers for tie layers, more preferably EVA. As in the case of the barrier layer, each reflective layer optionally contains additives within the skill in the art such as stabilizers, processing agents, antiblock agents, slip agents, and combinations thereof.

In a preferred embodiment, the multilayer structure includes at least one sealing or sealant layer in addition to at least one barrier layer and at least one UV protecting layer and preferably at least one reflecting layer. The sealing layer is any such layer within the skill in the art for instance as disclosed in such references as U.S. Pat. Nos. 6,117,465; 5,288,531; 5,360,648; 5,364,486; 5,508,051; 5,721,025; 4,521,437; 5,288,531; and 6,919,407 which are incorporated herein by reference to the fullest extent permitted by law. Preferred sealants comprise at least one low density polyethylene, ultra low density polyethylene, substantially linear ethylene polymer or combination thereof, preferably at least one substantially linear ethylene polymer such as those commercially available from The Dow Chemical Company under the trade designations Elite™, or Affinity™ or combinations thereof.

The thickness of the sealing layer is preferably at least about 0.5 mil (12.7 μm), more preferably at least about 0.75 mil (19.1 μm), most preferably at least about 1.0 mil (25.4 μm), and independently preferably at most about 2.5 mils (63.5 μm), more preferably at most about 2.0 mil (50.8 μm), most preferably at most about 1.5 mil (38.1 μm). In a preferred multilayer film such layers comprise preferably at least about 15 more preferably at least about 22 most preferably at least about 30, and independently preferably at most about 75, more preferably at most about 60, most preferably at most about 45 volume percent of the structure. Effectiveness of a sealant layer is often correlated to polymer density. In the case of ethylene polymer sealing layers the density is preferably at least about 0.93 g/cm³, more preferably at least about 0.91 g/cm³, most preferably at least about 0.89 g/cm³. In a pouch or other packaging that encloses a product, in order to form seams, the sealing layer is the inside layer and, thus contacts the package contents. Therefore, pigments, especially carbon black, are preferably avoided in the sealing layer to achieve preferred organoleptic qualities and to comply with food regulations in some regions.

Optionally low density polyethylene (LDPE) is blended into one or more layers to allow for easier extrusion by increasing shear thinning and to provide melt strength during film bubble formation.

One or more tie layers are optionally used between any layers of the multilayer structure of the invention, particularly any layers that have less than the desired adhesion to each other without the tie layer. Tie layers are within the skill in the art. Their composition is determined by that of the immediately adjacent layers such that the tie layer adheres to each immediately adjacent layer. Polymers comprising ethylene/vinyl acetate copolymer (EVA) are often used in tie layers adjacent polyvinylidene chloride. The vinyl acetate derived units are often present in amounts of about 12 to 35 weight percent for tie layer applications.

Those skilled in the art will recognize that one or more other layers within the skill in the art, for instance a strengthening layer, bulk layer, stiffening layer or the like or combination thereof are optionally included in a multilayer structure of the invention. However, these are not preferred in most situations when the multilayer structure is used to package UHT milk.

Speaking of the sealing layer as the inner layer, the outermost layer as the skin layer, with at least one barrier layer between them, the reflective layers are preferably nearer the skin layer, which is optionally and preferably a reflective layer, than the UV protecting layer which is preferably closer to the sealing layer so that the reflecting layer or combination thereof provides a desirable aesthetic appearance. Preferred structures include at least one of ACTABD, ATCTABD, AATCTAB, AATCTB, AATCB, ABCD, ACBD, ATBTCD, AAABTCTD, AAATCTBD, AABTCTD, or AATABBTCTD, wherein A is at least one reflective layer, B is at least one UV protecting layer, C is at least one barrier layer, D is at least one sealing layer, and T is at least one tie layer. More preferred structures include AACABD, ATCTBD, ACTABD, ATCTABD, AATCTAB, AATCTB, and AATCB, with AACABD, ATCTBD, ACTABD and ATCTABD, most preferred. Other structures within the scope of the invention include BC, ABC, ACB, BCD, CBD, ACD (where A is adequately reflective to also be UV protective), ACABD, BTC, ABTC, ATCTB, BTCTD, CTBD, ATCTD (where A is adequately reflective to also be UV protective), ATCTABD, and combinations thereof. In each of these structures, C optionally and preferably has layers of encapsulating polymer on either side of it, for instance as described in U.S. Pat. Nos. 6,685,872 or 4,842,791 which are incorporated herein by reference to the extent permitted by law. Preferred encapsulating polymers include ethylene vinyl acetate, ethylene methacrylate or combinations thereof. Any tie layer is optionally also reflective or UV protective or an AT, TA, BT, TB combination is optionally a single layer having both functions. Further, those skilled in the art will understand that there are optionally additional layers between the listed layers or even outside the skin layer, for instance a clear protective layer, a label layer that would be printed on either side thereof (clear label if printing is on the inside surface) or combination thereof without departing from the scope of the present invention.

At least one barrier layer, at least one UV protecting layer, optionally at least one white pigmented or reflective layer, at least one sealing layer and optionally other layers are formed into a multilayer structure, preferably a multilayer film, by any process within the skill in the art. Preferably the layers are coextruded, more preferably coextruded and blown or cast, most preferably coextruded and blown to form a film. Such processes are within the skill in the art. Simple blown bubble film processes are described, for example, in The Encyclopedia of Chemical Technology, Kirk-Othmer, Third Edition, John Wiley & Sons, New York, 1981, Vol. 16, pp. 416-417 and Vol. 18, pp. 191-192. The invention thus includes a process of (a) supplying at least one first composition comprising at least one vinylidene chloride polymer, at least one second composition comprising UV absorbing pigment or agent, and at least one third composition comprising at least one reflective pigment to a coextrusion die and (b) coextruding the first and second composition as layers; preferably expanding the coextruded layers to form a multilayer structure, preferably a film. Preferably at least one additional composition is also supplied to form at least one printable layer, at least one sealing layer or, more preferably a combination thereof. Those skilled in the art recognize that a coextruded film is structurally different from a laminated or bonded multilayer film in that the layers are more integral or uniform or a combination of both in the coextruded film that in the laminated or bonded film which may have irregular layers from melting and attachment or may have additional adhesive layers.

The invention includes the multilayer structure formed and additionally includes articles comprising at least one multilayer structure of the invention. Such articles include packaging or other containers, especially pouches, zipper bags and the like or combinations thereof. The preferred multilayer structure is a pouch having at least two seals in the transverse direction and preferably 0 to 2 seals in the machine direction, more preferably having seals in both the machine and transverse directions (pillow pouches), in one preferred embodiment most preferably two seals in each direction, in an alternative most preferred embodiment, preferably one seal in the machine direction and 2 in the transverse direction. This design allows the packager to produce pouches of any size for packaging product in various quantities as the market requires. Such seals are made by any means within the skill in the art.

When the multilayer structure or film of the invention is in the form of packaging, especially a pouch, it is preferably used to contain flowable material, preferably flowable material comprising at least a portion of liquid, more preferably a liquid product, at least at the time of filling. The packaging is preferably used for foodstuffs such as nuts, cereal, and other comminuted materials, more preferably for foods comprising liquids such as diced fruits or vegetables, ground, diced, or flaked meats or fish, or whole or ground spices in water, juice, wine, broth, gravy, sauce or oil, most preferably for liquids such as sauces, juices, wines, non-carbonated beverages, or, most preferably, milk.

Thus practice of the invention provides a multilayer structure capable of protecting UHT milk for a period of at least about 90 days, advantageously at least about 105 days, preferably at least about 120 days, more preferably at least about 150 days, most preferably at least about 6 months, preferably at ambient conditions, more preferably at ambient conditions of average temperature of at least about 24, more preferably at least about 25 or most preferably at least about 26° C., with an average daily high temperature over the time of storage of at advantageously most about 25, preferably at most about 29, more preferably at most about 30, most preferably at most about 31° C., and relative humidity of advantageously at least about 50, preferably at least about 55, more preferably at least about 60, most preferably at least about 65 and independently preferably at most about 85, more preferably at most about 87, most preferably at most about 89. The multilayer structure also has one or more of the following characteristics with increasing preference for increasing numbers of the characteristics: (1) a weight less than that of the polymer/foil/paper rigid container standardly used for UHT milk, preferably less than about 4, more preferably less than about 3, most preferably less than about 2.5 weight percent of the packaged milk in 1000 ml portions; (2) less susceptibility to cracking or pinholes in the barrier layer than foil; (3) capability to protect milk stored at ambient conditions for a period longer than that achieved with a comparable laminate using a different barrier layer such as ethylene vinyl alcohol (EVOH) under the same conditions; (4) less exacting packaging manufacture than a standard polymer/foil/paper laminate milk box or a standard polymer/foil or metallized film/polymer laminate for milk pouch; (5) is producible by coextrusion; or (6) ability to facilitate transportation or storage (or both) at ambient rather than refrigerated temperatures or at least raise the temperature at which a packaged product can be stored, transported, or both over the temperature that would be required to achieve the same shelf life or percentage of consumable product using alternate packaging such as a different barrier layer such as ethylene vinyl alcohol (EVOH). In comparing EVOH and PVDC barrier layers, it is well known that EVOH has a higher oxygen barrier (that is, lower absolute permeation value) than polyvinylidene chloride polymers at equivalent gauge under test conditions of ASTM D-3985, that is, conditions of 23 degrees Celsius and 0 percent relative humidity (RH). Therefore, those skilled in the art recognize that a comparison of layers expected to have similar standard oxygen barrier is more meaningful than comparison of barrier layers having the same thickness or percent of volume of a multilayer structure. For this reason, comparisons of effectiveness herein refer to comparisons of layers expected to have similar oxygen barrier properties as measured according to the procedures of ASTM D-3985. Compilations of barrier comparisons are published for instance in http://plastics.dow.com/plastics/na/techcenters/saran/perf/oxy.htm. A multilayer structure according to the practice of the invention when compared with a similar structure having an EVOH barrier layer expected to have similar oxygen barrier measured according to the practice of ASTM D 3985 is surprisingly more effective than the multilayer structure containing EVOH at preserving milk as a test product under ambient (non-refrigerated) conditions, especially in the presence of heat and humidity.

Objects and advantages of this invention are further illustrated by the following examples. The particular materials and amounts thereof, as well as other conditions and details, recited in these examples should not be used to limit this invention. Rather they are illustrative of the whole invention. Unless stated otherwise all percentages, parts and ratios are by weight. Examples of the invention are numbered while comparative samples, which are not examples of the invention, are designated alphabetically.

### EXAMPLES

### Example 1

A multilayer structure is formed from the following compositions for the specified layers:

Layer A: 12% of structure by volume, 98.44% by weight substantially linear polyethylene commercially available from Dow Chemical under the tradename ELITE™ 5500. This layer also contains 1% by weight of polymer process aid masterbatch in LLDPE commercially available from Ampacet under the designation 102113. In addition, 800 ppm of stearamide, 800 ppm of erucamide, and 4000 ppm of diatomaceous silica (Si02) are added.

Layer B: 21% of structure by volume, 77.44% by weight substantially linear polyethylene commercially available from Dow Chemical under the tradename ELITE™ 5500; 20% by weight carbon black masterbatch in LDPE commercially available from Ampacet under the designation 190405. In addition, 800 ppm of stearamide, 800 ppm of erucamide, and 4000 ppm of diatomaceous silica (SiO2) are added.

Layer C: 14% of structure by volume, 82.44% by weight EVA commercially available from E.I. DuPont de Nemours under the tradename ELVAX™ 3170; 15% by weight white masterbatch in LDPE/LLDPE commercially available from Ampacet under the designation 11560. In addition, 800 ppm of stearamide, 800 ppm of erucamide, and 4000 ppm of diatomaceous silica (SiO2) are added.

Layer EN: 14% of structure by volume. Outer 2% (4% total) by volume consists of 50% by weight EMA commercially available from Arkema under the tradename LOTRYL™ 24MA005 and 50% by weight EMA commercially available from Arkema under the tradename LOTRYL™ 29MA03. Inner 10% by volume consists of 100% by weight PVDC commercially available from Dow Chemical under the tradename SARAN™ XUS 32019.10L.

Layer D: 10% of structure by volume, 82.44% by weight EVA commercially available from E.I. DuPont de Nemours under the tradename ELVAX™ 3170; 15% by weight white masterbatch in LDPE/LLDPE commercially available from Ampacet under the designation 11560. In addition, 800 ppm of stearamide, 800 ppm of erucamide, and 4000 ppm of diatomaceous silica (SiO2) are added.

Layer E: 29% of structure by volume, 82.44% by weight linear polyethylene from Dow Chemical under the tradename DOWLEX™ 2247G; 15% by weight white masterbatch in LDPE/LLDPE commercially available from Ampacet under the designation 11560. This layer also contains 1% by weight of polymer process aid masterbatch in LLDPE commercially available from Ampacet under the designation 102113. In addition, 800 ppm of stearamide, 800 ppm of erucamide, and 4000 ppm of diatomaceous silica (SiO2) are added.

The film of Example 1 is produced on a conventional upward blown film line. This line consists of a 22″ (0.56 m) diameter blown film die that is fed by 6 discrete polymer streams. Four of these streams (A, B, D, and E) are supplied by single screw extruders equipped with 75 mm screws. One of the polymer streams (C) is supplied by a single screw extruder equipped with a 100 mm screw. The sixth stream consists of an encapsulated polymer stream (EN) that is generated according to the teachings of U.S. Pat. No. 6,685,872 which is incorporated herein to the extent permitted by law. To generate this encapsulated polymer stream EN, two independent single screw extruders (S, SE) are used to feed an encapsulation die. The output from the encapsulation die is polymer stream EN, which consists of a core stream (S) that is fully encapsulated by another stream (SE).

All of these extruders and screws are commercially available from Davis-Standard. The blown film die and the encapsulation die are both commercially available from Brampton Engineering, under the trade name ISOtherm SCD. The streams enter the blown film die and are “stacked” as follows: A, B, C, EN, D, E. Extruder and die conditions for extruders A, B, C, D, E, S, and SE are listed in Table 1 below.

TABLE 1
Conditions used to generate the film of Example 1

| Element | Value | SI UNIT CONVERSIONS |
|---|---|---|
| Extruder A Temperature Profile (degrees F): | 300/320/350/ | 149/160/177/193/204/ |
| Zone 1/Zone 2/Zone 3/Zone 4/Zone 5/ | 380/400/400/ | 204/204/204/204° C. |
| Zone 6/Screen Changer/Transfer Zone 8/ | 400/400/400 | |
| Transfer Zone 9 | | |
| Extruder B Temperature Profile (degrees F): | 300/320/350/380/ | 149/160/177/193/204/204/204/ |
| Zone 1/Zone 2/Zone 3/Zone 4/Zone 5/ | 400/400/400/400/ | 204/204° C. |
| Zone 6/Screen Changer/Transfer Zone 8/ | 400 | |
| Transfer Zone 9 | | |
| Extruder C Temperature Profile (degrees F): | 270/290/310/330/ | 132/143/154/166/171/ |
| Zone 1/Zone 2/Zone 3/Zone 4/Zone 5/ | 340/340/340/340/ | 171/171/171/171° C. |
| Zone 6/Screen Changer/Transfer Zone 8/ | 340 | |
| Transfer Zone 9 | | |
| Extruder D Temperature Profile (degrees F): | 270/290/310/330/ | 132/143/154/166/171/ |
| Zone 1/Zone 2/Zone 3/Zone 4/Zone 5/ | 340/340/340/340/ | 171/171/171/171° C. |
| Zone 6/Screen Changer/Transfer Zone 8/ | 340 | |
| Transfer Zone 9 | | |
| Extruder E Temperature Profile (degrees F): | 300/320/350/380/ | 149/160/177/193/204/204/204/ |
| Zone 1/Zone 2/Zone 3/Zone 4/Zone 5/ | 400/400/400/400/ | 204/204° C. |
| Zone 6/Screen Changer/Transfer Zone 8/ | 400 | |
| Transfer Zone 9 | | |
| Extruder S Temperature Profile (degrees F): | 320/320/340/340/ | 160/160/171/171/171° C. |
| Zone 1/Zone 2/Zone 3/Zone 4/ | 340 | |
| Encapsulation Die | | |
| Extruder SE Temperature Profile (degrees | 300/320/340/350/ | 149/160/171/177/177/ |
| F): | 350/350/350 | 177/177° C. |
| Zone 1/Zone 2/Zone 3/Screen Changer/ | | |
| Encapsulation Transfer Line/Encapsulation | | |
| Elbow/Transfer Line | | |
| Die Temperature Profile (degrees F): | 400/400/400/350/ | 204/204/204/177/166/ |
| Mandrel Bottom/Extruder A/Extruder B/ | 330/350/400/400/ | 177/204/204/204/204/ |
| Extruder C/EN Stream Oil Temperature/ | 400/400/400 | 204° C. |
| Extruder D/Extruder E/Outer Lip/Outer | | |
| Lip Land/Inner Lip Land/Mandrel | | |
| Extension | | |
| Extruder A/B/C/D/E/S/SE RPM: | 16/34/11/16/45/ | |
| | 26/34 | |
| Extruder A/B/C/D/E/S/SE Head Pressure | 3722/4887/3160/ | 25.6/33.7/21.8/20.4/25.2/ |
| (psi): | 2962/3648/3954/ | 27.3/25.2 MPa |
| | 3648 | |
| Extruder A/B/C/D/E/S/SE Output Rate (lb/h): | 89/158/113/80/291/ | 40.4/71.2/51.3/36.3/ |
| | 137/31 | 132/62.1/14 kg/h |
| Extruder A/B/C/D/E/S/SE Load (hP): | 30/38/43/21/37/ | 22.4/28.3/32.1/15.7/27.6/ |
| | 26/37 | 19.4/27.6 kW |
| Layflat (in): | 80 | 2.03 m |
| Line Speed (ft/min): | 61 | 0.31 m/s |
| Die Gap (mils): | 45 | 1143 μm |
| Blow up ratio: | 2.3:1 | |
| Film Gauge (mils): | 3.3 | 83.8 μm |

### Comparative Sample A

The film of Comparative Sample A is an 84 micron thick film with an ethylene vinyl alcohol (EVOH) barrier layer, commercially available from Carpak, Colombia. The following identification and layer thicknesses are based on hot stage, infrared (IR), differential scanning calorimetry (DSC) testing methods and a variety of light microscopy techniques and comparisons with known polymers.

Layer A: 30% of structure by volume. It contains polyethylene which is either, substantially linear polyethylene or linear low density polyethylene and may have a small component of high pressure low density polyethylene. The melting point of this layer is about 121° C.

Layer B: 13% of structure by volume. High pressure low density polyethylene and carbon black masterbatch in LDPE.

Layers C and E: 4% of structure by volume, tie layer for layer B and layer D with a melting point of about 98-99° C. Constituents are uncertain. Testing is consistent with a maleic anhydride grafted polymer.

Layer D: 5% of structure by volume. Ethylene Vinyl Alcohol, EVOH, with approximately 44 mol % ethylene content. The melting point for this layer is 163° C. according to DSC and 170° C. according to hot stage measurements.

Layers F and G: These are two consecutive layers with 43% of structure by volume (for both layers combined). It is primarily polyethylene, either substantially linear polyethylene or linear low density polyethylene, with the possibility of a small amount of high pressure low density polyethylene. These layers contain white masterbatch (and/or filler) in LDPE/LLDPE.

### Comparison of Example 1 and Comparative Sample A

Films of Comparison A and Example 1 are used to form milk pouches and package UHT milk in 1-L pouches. Both are packaged with same product, at the same time, from same aseptic packaging machine.

All pouches are stored (15 units of each Example 1 and Comparative Sample A) in ambient—non refrigerated—conditions in a warehouse located in Guayaquil, Ecuador. The pouches are placed inside a building at room temperature with no conditioning of any kind. The samples are packaged on Feb. 2, 2007 and shelf life testing is initiated the same day and continued through Jul. 31, 2007. Every 2 weeks one pouch of each material is tested using a sensory panel and analytical testing for the following:

Organoleptic: acceptable taste, odor, color, appearance for milk (sensory panel)

Physical-Chemical: pH (method Association of Analytical Communities (AOAC) 18^{th} 981.12), lactic acidity (AOAC 18^{th} 947.05), ethanol content (method Ecuadorian National Standards Institute (INEN) 1500), density.

Microbiological: Aerobe content (AOAC 18^{th} 986.33); Coliform content (AOAC 18^{th} 986.33)

In Guayaquil, Ecuador, the following temperatures are experienced on average according to historical weather data:

Average Temperature

| | Year | January | February | March | April | May | June | July | August | September | October | November | December |
|---|---|---|---|---|---|---|---|---|---|---|---|---|---|
| ° F. | 80 | 81 | 81 | 82 | 82 | 81 | 78 | 77 | 77 | 78 | 78 | 79 | 81 |
| ° C. | 26 | 27 | 27 | 27 | 27 | 27 | 25 | 25 | 25 | 25 | 25 | 26 | 27 |

Years Charted: 16
Source: International Station Meteorological Climate Summary, Version 4.0

Average High Temperature

| | Year | January | February | March | April | May | June | July | August | September | October | November | December |
|---|---|---|---|---|---|---|---|---|---|---|---|---|---|
| ° F. | 86 | 88 | 87 | 89 | 89 | 87 | 85 | 84 | 84 | 86 | 85 | 86 | 88 |
| ° C. | 30 | 31 | 30 | 31 | 31 | 30 | 29 | 28 | 28 | 30 | 29 | 30 | 31 |

Years Charted: 16
Source: International Station Meteorological Climate Summary, Version 4.0

Average Low Temperature

| | Year | January | February | March | April | May | June | July | August | September | October | November | December |
|---|---|---|---|---|---|---|---|---|---|---|---|---|---|
| ° F. | 72 | 74 | 75 | 76 | 75 | 74 | 72 | 70 | 69 | 70 | 71 | 72 | 73 |
| ° C. | 22 | 23 | 23 | 24 | 23 | 23 | 22 | 21 | 20 | 21 | 21 | 22 | 22 |

Years Charted: 16
Source: International Station Meteorological Climate Summary, Version 4.0

Highest Recorded Temperature

| | Year | January | February | March | April | May | June | July | August | September | October | November | December |
|---|---|---|---|---|---|---|---|---|---|---|---|---|---|
| ° F. | 100 | 97 | 97 | 97 | 95 | 95 | 93 | 93 | 93 | 93 | 93 | 100 | 95 |
| ° C. | 37 | 36 | 36 | 36 | 35 | 35 | 33 | 33 | 33 | 33 | 33 | 37 | 35 |

Years Charted: 16
Source: International Station Meteorological Climate Summary, Version 4.0

Lowest Recorded Temperature

| | Year | January | February | March | April | May | June | July | August | September | October | November | December |
|---|---|---|---|---|---|---|---|---|---|---|---|---|---|
| ° F. | 59 | 70 | 68 | 66 | 72 | 68 | 59 | 63 | 59 | 61 | 64 | 63 | 68 |
| ° C. | 15 | 21 | 20 | 18 | 22 | 20 | 15 | 17 | 15 | 16 | 17 | 17 | 20 |

Years Charted: 16
Source: International Station Meteorological Climate Summary, Version 4.0

Average Morning Relative Humidity

| | Total | January | February | March | April | May | June | July | August | September | October | November | December |
|---|---|---|---|---|---|---|---|---|---|---|---|---|---|
| % | 84 | 85 | 89 | 87 | 87 | 85 | 85 | 85 | 84 | 83 | 82 | 81 | 81 |

Years Charted: 15
Source: International Station Meteorological Climate Summary, Version 4.0

Average Afternoon Relative Humidity

| | Total | January | February | March | April | May | June | July | August | September | October | November | December |
|---|---|---|---|---|---|---|---|---|---|---|---|---|---|
| % | 59 | 60 | 64 | 61 | 62 | 61 | 62 | 60 | 57 | 56 | 57 | 55 | 54 |

Years Charted: 14
Source: International Station Meteorological Climate Summary, Version 4.0

The UHT milk packaged in the pouches made of the film of Comparative Sample A passed all the specifications on analysis performed on day 85 after packaged and fail the organoleptic specifications on day 101 after packaged. The UHT milk packaged in the pouches made of the film of Example 1 pass all specifications on analyses performed on day 158 after packaged and failed the organoleptic specifications on day 174 after packaged. Those skilled in the art recognize that such sources as Dow.com and Evalca.com teach that a vinylidene chloride/methyl acrylate barrier film of 10 percent of the thickness of the 84 micron thickness of the film of Example 1, or 8.4 microns, would have an expected oxygen transmission of 3.4 cc/m²-day-atm under standard conditions of 23 degrees Celsius and 0% RH according to the procedures of ASTM D 3985-05 while an ethylene vinyl acetate barrier film of 5% of the 84 micron thickness of Comparative Sample A, or 4.2, microns would be expected to provide an oxygen transmission of 1.5 cc/m²-day-atm under the same conditions. These results show that even though the barrier layers alone under standard conditions are expected to give similar results, milk pouches made according to the practice of the invention using a vinylidene chloride polymer barrier layer unexpectedly preserves milk about 73 days or about 85% longer than a similar commercial film using an ethylene vinyl acetate barrier layer under the ambient temperatures and humidity of coastal Ecuador during the first part of a year. This result shows the surprising value of the present invention in enabling transportation and storage of foodstuffs like milk without refrigeration.

Embodiments of the present invention include:

1. A multilayer structure comprising at least one barrier layer comprising at least one vinylidene chloride polymer and at least one UV protecting layer.
2. An article comprising at least one multilayer structure of any of the other embodiments.
3. A process comprising steps of (a) supplying at least one first composition comprising at least one vinylidene chloride polymer, at least one second composition comprising UV absorbing pigment or agent, and at least one third composition comprising at least one reflective material to a coextrusion die and (b) coextruding the first, second and third composition as layers.
4. The multilayer structure, article or process of any other embodiment wherein at least one additional composition is also supplied to form at least one additional reflective layer, at least one sealing layer or, preferably a combination thereof.
5. The multilayer structure, article or process of any other embodiment wherein the process additionally comprises a step of expanding the coextruded layers to form a multilayer structure.
6. The multilayer structure, article or process of any other embodiment wherein the multilayer structure is a film.
7. The multilayer structure, article or process of any other embodiment wherein the vinylidene chloride polymer is at least one alkyl acrylate vinylidene chloride interpolymer.
8. The multilayer structure, article or process of any other embodiment wherein the acrylate is selected from methyl acrylate, ethyl acrylate, propyl acrylate or butyl acrylate or a combination thereof.
9. The multilayer structure, article or process of any other embodiment wherein the acrylate is selected from methyl or butyl acrylate or a combination thereof.
10. The multilayer structure, article or process of any other embodiment wherein the acrylate is methyl acrylate.
11. The multilayer structure, article or process of any other embodiment wherein the barrier layer or layers comprise at least about any of 80, 85, 90, or 95 percent by weight of polyvinylidene chloride polymer.
12. The multilayer structure, article or process of any other embodiment wherein the barrier layer is preferably at least about any of 8, 10, 12, and independently at most about any of 20, 18, or 16 percent by volume of the multilayer structure.
13. The multilayer structure, article or process of any other embodiment wherein the total film thickness is at least about any of 2.2 mils (55.9 μm), 2.7 mils (68.6 μm), or 3.3 mils (83.8 μm), and independently at most about any of 5.5 mils (139.7 μm), 5.0 mils (127 μm), or 4.5 mils (114.3 μm).
14. The multilayer structure, article or process of any other embodiment wherein the UV protecting layer comprises at least one layer comprising at least one dark pigment, that is a pigment capable of absorbing ultra violet (UV) light, or other UV absorbent or combination thereof.
15. The multilayer structure, article or process of any other embodiment wherein the pigment or UV absorbent is selected from, carbon black, HALS (hindered amine light scattering additives) and combinations thereof.
16. The multilayer structure, article or process of any other embodiment wherein the UV protecting layer is preferably pigmented with a dark pigment.
17. The multilayer structure, article or process of any other embodiment wherein the dark pigment or UV absorbent or combination thereof are present in an amount sufficient to result in a L* (transmittance) value at most about any of 2, 1.5 or 1.0.
18. The multilayer structure, article or process of any other embodiment wherein the UV absorbent comprises carbon black and is present at a concentration of at most about any of 5, 4, 3 percent by weight carbon black in polymer.
19. The multilayer structure, article or process of any other embodiment wherein the UV protecting layer or combination thereof comprise at least about make up about 20 percent of the volume of the multilayer film.
20. The multilayer structure, article or process of any other embodiment wherein the UV protecting layer comprises a polymer selected from low density polyethylene, ethylene-octene copolymers, ethylene-vinyl acetate copolymers, ethylene methyl acrylate copolymers or combinations thereof, preferably comprising ethylene polymers or combinations thereof.
21. The multilayer structure, article or process of any other embodiment wherein more than one UV protecting layer is present.
22. The multilayer structure, article or process of any other embodiment wherein the combined thickness of the UV protecting layer or layers in the multilayer structure is at least about any of 0.3 mil (7.6 μm), 0.5 mil (12.7 μm), 0.7 mil (17.8 μm), and independently preferably at most about any of 1.5 mil (38.1 μm), 1.3 mil (53.0 μm), or 1.1 mil (27.9 μm).
23. The multilayer structure, article or process of any other embodiment wherein the combined thickness (volume) of the UV protecting layer or layers in the multilayer structure at least about any of 10, 15, 20, and independently at most about any of 40, 35, 30 volume percent of the structure.
24. The multilayer structure, article or process of any other embodiment wherein there is additionally at least one reflective layer in the multilayer structure.
25. The multilayer structure, article or process of any other embodiment wherein each reflective layer independently comprises at least one of white pigment, silver, aluminum, or other metallic pigment or has a reflective coating or a combination thereof.
26. The multilayer structure, article or process of any other embodiment wherein the white pigment comprises titanium dioxide or combinations therewith.
27. The multilayer structure, article or process of any other embodiment wherein the reflective layer is preferably sufficiently reflective to accomplish those of the following purposes appropriate for a preselected end use: protection from light, protection from heat, aesthetic appeal, printability, or a combination thereof.
28. The multilayer structure, article or process of any other embodiment wherein the reflective layer comprises an amount of reflective or white pigment sufficient to result in a L* (reflectance) value as determined by the procedures of ASTM E308-06 of preferably at least about any of 75, 80, or 85.
29. The multilayer structure, article or process of any other embodiment wherein the reflective or white pigment is present in an amount of at least about any of 2, 4, or 6 and independently at most about any of 20, 15, or 10 weight percent of each reflective layer.
30. The multilayer structure, article or process of any other embodiment wherein the outermost or external layer is suitable for printing.
31. The multilayer structure, article or process of any other embodiment wherein there is more than one reflective layer.
32. The multilayer structure, article or process of any other embodiment wherein the combined thickness of the reflective layer or layers is at least about any of 1 mil (25.4 μm), 1.25 mils (31.8 μm), or 1.50 mils (38.1 μm), and independently at most about any of 2.50 mils (63.5 μm), 2.25 mils (57.2 μm), or 2.0 mils (50.8 μm).
33. The multilayer structure, article or process of any other embodiment wherein the combined thickness (volume) of the reflective layer or layers comprises at least about any of 10, 20, or 30, and independently at most about any of 60, 50, 40 volume percent of the structure.
34. The multilayer structure, article or process of any other embodiment wherein the reflective layer or layers (including any coating or coatings thereon) also reflects at least about 95 percent of UV light that reaches the structure and is, therefore also a UV protecting layer.
35. The multilayer structure, article or process of any other embodiment wherein the reflective layer comprises at least one polymer selected from linear low density polyethylene (LLDPE), ethylene-octene copolymers, substantially linear ethylene polymers, low density polyethylene, nylon, polypropylene or combinations thereof, preferably comprising at least one ethylene polymers or combinations thereof, more preferably at least one LLDPE or combination thereof, most preferably with at least one other ethylene polymer.
36. The multilayer structure, article or process of any other embodiment wherein the multilayer also comprises at least one tie layer.
37. The multilayer structure, article or process of any other embodiment wherein at least one reflective layer is also printable.
38. The multilayer structure, article or process of any other embodiment wherein at least one reflective layer is also a tie layer.
39. The multilayer structure, article or process of any other embodiment wherein at least one tie layer is also a reflective or UV protective layer or a combination thereof.
40. The multilayer structure, article or process of any other embodiment wherein at least one reflective layer comprises ethylene vinyl acetate (EVA) or substantially linear ethylene polymers or a combination thereof, more preferably EVA or a combination therewith.
41. The multilayer structure, article or process of any other embodiment wherein the multilayer structure additionally comprises one sealing or sealant layer.
42. The multilayer structure, article or process of any other embodiment wherein at least one reflective layer, at least one barrier layer, and at least one UV protecting layer do not function as a sealing layer, preferably wherein none of the reflective layers, barrier layers, or UV protective layers serve as a sealing layer, most preferably wherein there is a sealing layer separate from the barrier, reflecting and UV protecting layers.
43. The multilayer structure, article or process of any other embodiment wherein at least one sealing layer comprises at least one low density polyethylene, ultra low density polyethylene, substantially linear ethylene polymer or combination thereof, preferably at least one substantially linear ethylene polymer or combination thereof.
44. The multilayer structure, article or process of any other embodiment wherein each sealing layer has a thickness of at least about any of 0.5 mil (12.7 μm), 0.75 mil (19.1 μm), or 1.0 mil (25.4 μm), and independently at most about any of 2.5 mils (63.5 μm), 2.0 mils (50.8 μm), 1.5 mil (38.1 μm).
45. The multilayer structure, article or process of any other embodiment wherein the sealing layer or combination thereof comprise at least about any of 15, 22 or 30, and independently at most about any of 75, 60, or 45 volume percent of the multilayer structure.
46. The multilayer structure, article or process of any other embodiment wherein the density of at least one polymer in the sealing layer is at least about any of 0.93, 0.91 or 0.89 g/cm³.
47. The multilayer structure, article or process of any other embodiment wherein the sealing layer contains essentially no white or dark pigment, preferably no carbon black.
48. The multilayer structure, article or process of any other embodiment wherein the multilayer structure comprises ABCD, ACBD, ATBTCD, AAABTCTD, AAATCTBD, AABTCTD, or AATABBTCTD, ACABD, BC, ABC, ACB, BCD, CBD, ACD (where A is adequately reflective to also be UV protective), BTC, ABTC, ATCTB, BTCTD, CTBD, ATCTD (where A is adequately reflective to also be UV protective), ATCTABD, or a combination thereof, preferably ABCD, ACBD, ATBTCD, AAABTCTD, AAATCTBD, AABTCTD, or AATABBTCTD, ACABD, or a combination thereof, more preferably AACABD, ATCTBD, ACTABD, ATCTABD, AATCTAB, AATCTB, AATCB, or a combination thereof, most preferably AACABD, ATCTBD, ACTABD ATCTABD or a combination thereof wherein A is at least one reflective layer, B is at least one UV protecting layer, C is at least one barrier layer, D is at least one sealing layer, and T is at least one tie layer and in each instance C optionally has encapsulating layers on either side of it.
49. The multilayer structure, article or process of any other embodiment wherein at least one barrier layer has encapsulating polymer on either side of it.
50. The multilayer structure, article or process of any other embodiment wherein the encapsulating polymer comprises at least one of ethylene vinyl acetate, ethylene methacrylate or combinations thereof.
51. The multilayer structure, article or process of any other embodiment wherein the article is selected from at least one pouch, zipper bag, container, packaging or combination thereof.
52. The multilayer structure, article or process of any other embodiment wherein the article is a pouch.
53. The multilayer structure, article or process of any other embodiment wherein the pouch has at 0-2, in one embodiment preferably 1 and in an alternative embodiment, preferably 2, seals in the machine direction and at least 2 seals in the transverse direction.
54. The multilayer structure, article or process of any other embodiment wherein the pouch or packaging is suitable for containing flowable material.
55. The multilayer structure, article or process of any other embodiment wherein the article is a milk pouch.
56. The multilayer structure, article or process of any other embodiment wherein the milk pouch is capable of protecting UHT milk for a period of at least about any of 90, 105, 120, or 150 days, or 6 months, preferably at ambient conditions, more preferably at ambient conditions of average temperatures of about any of 24, 25 or 26° C., with average high temperatures over the time of storage of about any of 25, 29, 30 or 31° C., and relative humidity of at least about any of 50, 55, 60 or 65 to at most about any of 85, 87 or 89.
57. The multilayer structure, article or process of any other embodiment wherein the multilayer structure has one or more of the following characteristics with increasing preference for increasing numbers of the characteristics: (1) a weight less than that of the polymer/foil/paper rigid container commercially used for UHT milk, preferably less than about any of 4, 3, 2.5 weight percent of the packaged milk in 1000 ml portions; (2) less susceptibility to cracking or pinholes in the barrier layer than foil; (3) capability to protect milk stored at ambient conditions for a period longer than that achieved with a comparable laminate using ethylene vinyl alcohol (EVOH) as a barrier layer under the same conditions; (4) less exacting packaging manufacture than a standard polymer/foil/paper laminate milk box or a standard polymer/foil or metalized film/polymer laminate for milk pouch; (5) is producible by coextrusion; or (6) ability to facilitate transportation or storage (or both) at ambient rather than refrigerated temperatures or at least raise the temperature at which a packaged product can be stored, transported, or both over the temperature that would be required to achieve the same shelf life or percentage of consumable product using alternate packaging having ethylene vinyl alcohol (EVOH) as the barrier layer.

1. A multilayer structure having at least one barrier layer comprising at least one vinylidene chloride polymer, at least one UV protecting layer, and at least one reflective layer wherein none of these layers also serve as a sealing layer.

2. The multilayer structure of claim 1 wherein there are more than one reflective layers.

3. The multilayer structure of claim 1 wherein the barrier layer comprises at least one vinylidene chloride/methyl acrylate copolymer, the UV protecting layer comprises at least one low density polyethylene, ethylene/octene polymer, ethylene/vinyl acetate copolymer, substantially linear ethylene polymer, ethylene/methyl acrylate copolymer or combination thereof and at least one carbon black or hindered amine light scattering additive (HALS) or combination thereof; the reflective layer comprises at least one low density polyethylene, ethylene/octene polymer, ethylene/vinyl acetate copolymer, substantially linear ethylene polymer, ethylene/methyl acrylate copolymer or combination thereof and titanium dioxide, a metallic pigment or combination thereof; any sealant layer comprises at least one low density polyethylene, ultra low density polyethylene, substantially linear polyethylene or a combination thereof, any tie layer comprises ethylene/vinyl acetate copolymer, and any encapsulating layer comprises ethylene/vinyl acetate copolymer, ethylene/methacrylate copolymer or combination[s] thereof.

4. The multilayer structure of claim 1 wherein the UV protecting layer or layers together comprise at least about 10 and at most about 40, the reflective layer or layers together comprise at least about 10 and at most about 60, and any sealant layers comprise at least about 20 and at most about 40 volume percent of the multilayer structure.

5. The multilayer structure of claim 1 wherein the multilayer structure comprising layers represented by AACABD, ATCTBD, ACTABD ATCTABD or a combination thereof in the indicated sequence wherein A is at least one reflective layer, B is at least one UV protecting layer, C is at least one barrier layer, D is at least one sealing layer, and T is at least one tie layer.

6. The multilayer structure of claim 1 wherein the barrier layer C has an encapsulating layers on either side of it on both major surfaces thereof.

7. The multilayer structure of claim 1 wherein pigment is essentially absent from any sealant layer.

8. A process comprising steps of (a) supplying at least one first composition comprising at least one vinylidene chloride polymer, at least one second composition comprising UV absorbing pigment or agent, and at least one third composition comprising at least one light reflective material, to a coextrusion die and (b) coextruding the first, second and third compositions as layers referred to herein after as the barrier layer, UV protecting layer, and reflective layer, respectively.

9. The process of claim 8 additionally comprising a step of expanding the coextruded layers to form a multilayer structure.

10. The process of claim 8 wherein step (a) additionally comprises supplying at least one additional composition to form at least one additional reflective layer, at least one sealing layer or both.

11. The process of claim 8 wherein there are steps of forming at least 2 transverse and 2 machine direction seals to form a pouch.

12. An article comprising at least one multilayer structure of claim 1.

13. The article of claim 12 comprising packaging, a container, a bag, a pouch or a combination thereof.

14. The article of claim 13 in the form of a pouch having 0 to 2 machine direction seams and two transverse direction seams.

15. The article of claim 12 comprising at least one milk pouch capable of maintaining potability of milk at ambient conditions of at least about an average of 25° C. and 50 percent relative humidity for a period of at least about 105 days or for a period longer than that of a similar pouch wherein the barrier layer is ethylene/vinyl alcohol copolymer compared at a relative thickness expected to have comparable oxygen barrier measured according to the procedures of ASTM E3985.

16. The multilayer structure of claim 2 wherein the UV protecting layer or layers together comprise at least about 10 and at most about 40, the reflective layer or layers together comprise at least about 10 and at most about 60, and any sealant layers comprise at least about 20 and at most about 40 volume percent of the multilayer structure.

17. The multilayer structure of claim 1 wherein the reflective layer comprises an amount of reflective or white pigment sufficient to result in a L* (reflectance) value as determined by the procedures of ASTM E308-06 of preferably at least about 75.

18. The article of claim 12 wherein the barrier layer comprises at least one vinylidene chloride/methyl acrylate copolymer, the UV protecting layer comprises at least one low density polyethylene, ethylene octene polymer, ethylene/vinyl acetate copolymer, substantially linear ethylene polymer, ethylene/methyl acrylate copolymer or combination thereof and at least one carbon black or hindered amine light scattering additive (HALS) or combination thereof; the reflective layer comprises at least one low density polyethylene, ethylene octene polymer, ethylene/vinyl acetate copolymer, substantially linear ethylene polymer, ethylene/methyl acrylate copolymer or combination thereof and titanium dioxide, a metallic pigment or combination thereof; any sealant layer comprises at least one low density polyethylene, ultra low density polyethylene, substantially linear polyethylene or a combination thereof, any tie layer comprises ethylene/vinyl acetate copolymer, and any encapsulating layer comprises ethylene/vinyl acetate copolymer, ethylene/methacrylate copolymer or combination thereof.

19. The article of claim 17 wherein there are more than one reflective layers.

20. The article of claim 17 wherein pigment is essentially absent from any sealant layer.
